(19) United States
(12) Patent Application Publication
(10) Pub. No.: US 2011/0238314 A1
(43) Pub. Date: Sep. 29, 2011

(54) Methodology for Short-term and Impending Earthquake Prediction

(76) Inventors: Zuji Qiang, Beijing (CN); Zhongshu Hu, Changchu City (CN); Xieli Zang, Baishan City (CN); Fenghou Hu, Changchun City (CN); Bo Liu, Tonghua City (CN); Zuoxun Zeng, Wuhan City (CN); Jin Qiang, Beijing (CN)

(21) Appl. No.: 12/943,246

(22) Filed: Nov. 10, 2010

(30) Foreign Application Priority Data
Mar. 25, 2010 (CN) 201010131858.3

(51) Int. Cl. G01V 1/00

(52) U.S. Cl. 702/15

(57) ABSTRACT

Short-term and impending earthquake prediction using orbiting satellites equipped with infrared wave scanners, receivers and image processors. The color densities of infrared images are categorized and applied to different seasons and latitudes to obtain an atmospheric model. The scanners detect the grayness value, from which the actual temperature can be obtained after modification of the atmospheric model. A ring of temperature decrease might appear above the cloud layer where the earthquake is breeding. Strange-shaped clouds might occur over the area. When the earthquake occurs in an inland highland area, thermal stress lines can be observed and the area where these stress lines converge is the future epicenter for an earthquake. A network of infrasonic sound measuring instruments detects infrasonic sound anomalies to improve the accuracy of predicting the time and epicenter of an earthquake. The invention can increase the rate of successful earthquake forecasting by 50%.

This application claims priority from Chinese patent application serial number CN 201010131858.3, filed Mar. 25, 2010.

### FIELD OF THE INVENTION

This invention is concerned with a methodology for predicting short-term and impending earthquakes by detecting and measuring temperature and sound anomalies. More particularly, the invention uses a network of infrasonic sound detectors to detect infrasonic sound anomalies and satellite-based temperature detectors to detect thermal infrared temperature brightness anomalies to accurately forecast the short-term and impending time, location and magnitude of an earthquake. The invention belongs to the field of remote sensing and seismology.

### BACKGROUND OF THE INVENTION

The study of earthquake prediction has been conducted for decades both at home and abroad, yet accurate prediction of earthquakes, especially short-term and impending prediction, remains a major unresolved problem.

There are four gaseous rings or layers around the earth, plus the atmosphere ring outside the earth. These five gas layers interact with each other. Before an earthquake happens, the rock layers around the earthquake epicenter are under stress. Fissures appear, leading to degassing. The emission of CH⁴, CO², CO, H², H⁺, He and H²O from the depths of the earth can result in a temperature drop in the cloud layer or a temperature increase at the earth's surface.

Experiments have been conducted by applicants since October, 1989 and dozens of earthquakes have been successfully predicted. Applicants have used the American Noah Extreme Orbit Satellite which is loaded with infrared wave band scanner, the Japanese Sunflower Stationary Satellite and the China Fengyun No. 1 and No. 2 Satellites to observe. The extreme orbit satellite scans an area 2800 kilometers wide and thousands of kilometers long, and the stationary satellite can cover an area of 6000 to 10000 square kilometers. The satellite images can be obtained in an hour. The Noah satellite and Sunflower Satellite can detect the temperature brightness. The former has a resolution of 0.5° C. in calculating the temperature brightness, while the latter has a high resolution of time.

Applicant applied for a Chinese patent on Mar. 15, 1990, patent number CN 9010272.6, titled “Making Impending Earthquake Prediction by Using the Satellite Thermal Infrared Temperature Brightness Anomaly”. With the availability of new information, it was changed on Mar. 5, 1999 to “Making Short-Term Earthquake Prediction by Using the Satellite Thermal Infrared Temperature Brightness Anomaly”, patent number CN97100774.8.

Applicants have made remarkable progress in the field, and the following breakthroughs have been achieved.

Aside from the temperature rise anomaly, there are special pre-earthquake precursors.

1. A ring of temperature fall might occur above the cloud layer over the earthquake-pregnant area. It indicates the existence of pre-earthquake conditions in the region. For instance, there appeared a ring of temperature drop in the cloud before the Zhangbei-Shangyi M 6.2 on Jan. 10, 1998, in East China.

2. There appeared a circle of brightness temperature increase above the earthquake-pregnant area 7 and 13 days before the Wenchuang Earthquake in Sichuang in 2008. The upward turbine movement is the main hot stress field.

3. When the earthquake happens in an inland highland area, the temperature increase anomaly might occur in a low-lying river area. Due to the complicated terrain, it is hard to detect and spot the precursors. By linking the temperature-increasing areas, we can find certain stress hotlines. The future epicenter is usually located where the hotlines converge, such as the Naqumani Earthquake M7.5 in Tibet on Nov. 8, 1997, the Jiji M7.6 Earthquake in Taiwan, on Sep. 21, 1999, the Kunlunshankouxi M8.1, on Nov. 14, 2001, the Wenchuang Earthquake M8.0, Sichuang Province, 2008, and the Haiti Earthquake M7.3, on Jan. 13, 2009, and the Chile Earthquake M8.8, on Feb. 27, 2010.

Due to frequent earthquakes in recent years, applicants have accumulated new data during their research, especially with the launch of satellites loaded with microwave temperature detectors. Hence, applicants have made use of the satellite thermal infrared temperature brightness anomaly for the short-term and impending earthquake prediction of strong earthquakes.

Despite the progress, there is room for further improvement and statistics show that the success rate can be enhanced even further. The area for a future epicenter needs to be narrowed down, the time needs to be categorized into short term and impending, and the interferences of the cloud layer and other factors should be excluded.

For instance, measurement of the thermal infrared stress field can not sufficiently accurately predict the time of the earthquake. When the temperature reached high enough to be forecast on Dec. 17, 1995, before the Lijiang Earthquake in Yunan Province on Feb. 3, 1996, there was a gap of 48 days between the measurement and the occurrence of the earthquake. Another instance was the San-Simon Earthquake (M 6.5) in California in the U.S.A. on Dec. 22, 2003. The X-shaped stress field formed around the epicenter and the surrounding area on Oct. 24, with the X shape indicating the epicenter. However, there were 59 days left before the actual earthquake.

### SUMMARY OF THE INVENTION

The aim of the present invention is to improve the success rate of short-term and impending earthquake prediction by narrowing down the possible area of the epicenter, by categorizing the time into short-term and impending, and by further excluding interfering factors. It has been applied to earthquake predictions worldwide so that it can help reduce the harm done to human beings.

The present invention detects infrasonic sound anomalies in conjunction with detection of thermal infrared temperature brightness anomalies detected by satellite-based instruments to accurately forecast the short-term and impending time, location and magnitude of an earthquake.

Temperature anomalies are detected by integrating satellite remote sensing thermal infrared technology with global observation and capturing the abrupt temperature rise and fall on the earth's surface due to the earth and atmosphere coupling. This phenomenon is different from the normal temperature changes due to the climate. The thermal infrared temperature drop is related closely to earthquake.

When the anomaly change in the temperature brightness and the temperature anomaly in absolute terms are calculated at the same time, dynamic evolution of the temperature on the ground and on the water surface and the features of the hot and cold stress field can be accurately determined Since the satellite can offer infrared data accurately and the data covers a wide area and its information is transmitted very fast, the successful rate of forecasting can be greatly improved.

Detection of infrasonic sound anomalies in accordance with the present invention greatly improves the accuracy of prediction of the time, location of the epicenter and the magnitude of a future earthquake. The infrasonic instrument works best at frequencies less than 1 Hz. When the infrasonic instrument records an abnormal phenomenon, there will be an earthquake within 10 days. The volume of the anomaly is related to the magnitude of the earthquake. The normal field is around 100 Hz. It reached 3200 Hz during the Wenchuan Earthquake in Sichuan Province. The arrangement of a network of infrasonic instruments enables the network to utilize the differences in time in detection of the signals by the infrasonic instruments to tell from which direction the sound comes. Therefore, the epicenter can be accurately predicted. In China for instance, the city of Wuhan has been selected as the data center. It extends to the cities of Chongqing, Beijing and Fuzhou, then further towards the cities of Kunming, Nanning and Lanzhou, until it reaches farthest to the cities of Changchun, Wulumuqi and Lasa. The distances between the cities range from 500-800, to 1000-1500, and 2000-2500 kilometers.

### DETAILED DESCRIPTION OF THE PREFERRED EMBODIMENT

The short-term earthquake prediction methodology of the invention uses orbiting satellites capable of thermal infrared imaging to detect the thermal infrared color density for geographical areas, and categorizes or grades the color densities for different seasons and different latitudes to establish an atmospheric model or data for normal climate factors. An increase and/or decrease in the detected temperature, after being corrected for the atmospheric model, indicates a temperature anomaly in the area that is a precursor of an earthquake. Infrasonic sound instruments are used to detect infrasonic sound anomalies that in conjunction with the temperature anomalies enable accurate prediction of the time, epicenter and magnitude of short term and impending earthquakes. Other precursors may also exist.

More particularly, the method of the invention uses an extreme orbit satellite, a stationary meteorology satellite, and small satellite groups equipped with infrared wave scanners, receivers, and image processors to detect thermal infrared temperature brightness anomalies in geographic areas, wherein the oceanic potential heat volume is integrated with data obtained from the satellites and processed by the image processors. Different color densities are graded using the satellite receivers and image processors to obtain an atmospheric model, and the grading of color density is applied to different seasons and different latitudes to determine the temperature brightness anomaly, wherein the color density, or the temperature brightness, usually stands between 0.5° K and 5.0° K. The atmospheric model is modified to obtain the grayness value of the real temperature, thereby determining whether the temperature increase or decrease is caused by an earthquake or by the climate based on the shape of the region and the shape of clouds above the region, therefore excluding the interference of the terrain and the weather.

The relationship between the three elements of earthquakes and the pre-earthquake thermal infrared temperature brightness anomalies and their evolution are:

1) Time: For an earthquake of magnitude equal to or greater than 5 (M≧5) a thermal infrared temperature brightness anomaly occurs 10 to 20 days before the earthquake, covering an area of 100,000 to 600,000 square kilometers. In an area with a thicker layer of rocks the infrared temperature brightness anomaly occurs 30-120 days prior to the earthquake. When there is cloud cover, a ring of temperature decrease may appear above the clouds as an earthquake precursor.

2) Epicenter: There are three types of epicenters: (1) The future epicenter and its surrounding areas. The anomaly appears in the epicenter. As the temperature increase expands in the outer area and encroaches upon the epicenter, the two temperature increase anomaly areas converge and the verge where the temperature anomaly moves forward is the future epicenter. (2) In another type, the temperature anomaly advances towards the epicenter as time goes by. The epicenter is where the temperature increase zone is moving forward or converges with the structure belt. (3) The third type happens in an inland area, where the temperature increase occurs in a low-lying river area. By linking the temperature increase zones, location of the stress lines can be determined. The epicenter is located where the stress lines meet.

3) Magnitude: An earthquake of magnitude 5 or greater (M≧5) usually covers an area of 100,000 square kilometers, an earthquake of magnitude 6 or greater (M≧6) usually covers an area of 400,000 square kilometers, and an earthquake of magnitude 7 or greater (M≧7) usually covers an area of 700,000 square kilometers.

Before the occurrence of an earthquake the temperature anomaly might appear as a ring of temperature decrease above an earthquake-pregnant area. Strange-shaped clouds might appear above the earthquake-pregnant area. In an inland area the temperature anomaly might appear in a low-lying river valley and by linking the temperature increase areas certain stress heat lines can be seen to converge at the future epicenter, thereby providing an indication of the future epicenter.

The color density, or the temperature brightness, usually stands between 0.5° K and 5.0° K. The temperature brightness categories of N40° and N10° to 35° latitudes are separated. The temperature value for the category N10° to N35° is between 2° K to 3° K, and 1° K. for N40°. In a tropical region (such as Indonesia) the temperature value is 5.0° K, and in a polar region (such as New Zealand and Iceland) the temperature value is 0.5° K. Different temperature brightness value can be applied in summer and winter. The scanners can get the grayness value from which the actual temperature can be obtained after modification of the atmospheric model by adding or subtracting 1° K.

The temperature increase and decrease caused by climate should be distinguished from those caused by earthquake. For instance, if the anomaly temperature increase crosses different terrains from 12 to 18 GMT within one day, it is regarded as an earthquake precursor. Otherwise, it is the result of climate factors.

Applicants have made 62 successful predictions out of 99 earthquakes of magnitude 5 or greater (M≧5) since October, 1989, with accurate prediction of time, epicenter and magnitude.

Valuable information about the time, the epicenter and the magnitude of a future earthquake can be obtained with the present invention, assisted by infrasonic wave instruments. The infrasonic instrument works best under 1 Hz. When the infrasonic instrument records the abnormal phenomenon, there will be an earthquake within 10 days. The normal field is around 100 Hz. It reached 3200 Hz during the Wenchuan Earthquake in Sichuan Province. The volume of the anomaly is related to the magnitude of the earthquake. Measurement of the thermal infrared stress field can not sufficiently accurately predict the time of the earthquake. When the temperature reached high enough to be forecast on Dec. 17, 1995, before the Lijiang Earthquake in Yunan Province on Feb. 3, 1996, there was a gap of 48 days between the measurement and the occurrence of the earthquake. Another instance was the San-Simon Earthquake (M 6.5) in California in the U.S.A. on Dec. 22, 2003. The X-shaped stress field formed around the epicenter and the surrounding area on October 24, with the X shape indicating the epicenter. There were 59 days left before the actual earthquake. This is where the use of infrasonic instruments to detect and measure infrasonic sound anomalies can significantly improve the accuracy of predicting an earthquake. The arrangement of a network of infrasonic instruments enables the network to utilize the differences in time in detection of the signals by the infrasonic instruments to tell from which direction the sound comes. Therefore, the epicenter can be accurately predicted. Take China for instance. The city of Wuhan has been selected as the data center. It extends to the cities of Chongqing, Beijing and Fuzhou, then further towards the cities of Kunming, Nanning and Lanzhou, until it reaches farthest to the cities of Changchun, Wulumuqi and Lasa. The distances between the cities range from 500-800, to 1000-1500, and 2000-2500 kilometers.

Following are examples of successful forecastings:

The temperature increase anomaly appeared in Chongsheng Haicao in northeast Taiwan on Apr. 16, 1992. By April 17, three days before the earthquake, the temperature increase expanded northwest and south and crossed east Taiwan towards Hualian region. Three days later, on April 20^{th}, the earthquake having a magnitude of 6.8 (M 6.8) occurred. In the Yakeba Gulf in Jordan the isolated temperature increase occurred ten days before the Yakeba Earthquake M 7.5 on Nov. 22, 1995. It shows that there is a strong link between the earthquake and the infrared temperature increase.

In the Jiashi Earthquake M6.6 in Xinjiang, on Aug. 27, 1998, 15 days before the earthquake, the isolated temperature occurred on August 13^{th} in the Talimu area. On August 1^{st}, two stress lines (NE, EW) converged near Jiashi. Applicants made the short-term earthquake predictions including the three elements. Subsequently, the M6.6 earthquake happened on 27^{th}, the biggest in China since 1998. Using the technology of the present invention, applicants made accurate prediction of the three elements.

Nine days before the Jiji M7.6 Earthquake in Taiwan on Sep. 21, 1999, the stress field showed the shape of an arm, reaching into the west earthquake belt in Taiwan. This time applicants missed the epicenter by 40 kilometers, but did fine with the time and magnitude.

Seven days before the Wenchuang Earthquake M8.0, Sichuang Province, on May 12, 2008, the stress fields converged and there was cold gas from under the epicenter.

Although particular embodiments of the invention are illustrated and described in detail herein, it is to be understood that various changes and modifications may be made to the invention without departing from the spirit and intent of the invention as defined by the scope of the appended claims.

What is claimed is:

1. A method of short-term and impending earthquake prediction, comprising the steps of:
a) using an extreme orbit satellite, a stationary meteorology satellite, and small satellite groups equipped with infrared wave scanners, receivers, and image processors to detect thermal infrared temperature brightness anomalies in geographic areas;
b) integrating oceanic potential heat volume and data obtained from the satellites and the satellite remote sensing brightness temperature which has been processed by the image processors;
c) utilizing the satellite receivers and image processors to grade different color density of the satellite thermal infrared imaging to obtain an atmospheric model;
d) applying the grading of color density to different seasons and different latitudes to determine the satellite thermal infrared temperature brightness anomaly, wherein the color density, or the temperature brightness, usually stands between 0.5° K and 5.0° K;
e) obtaining the grayness value after modification of the atmospheric model to obtain the real temperature by adding or subtracting 1° K according to the real situation in different regions, thereby determining whether the temperature increase or decrease is caused by an earthquake or by the climate based on the shape of the region and the shape of clouds above the region, therefore excluding the interference of the terrain and the weather; wherein:
the three elements of short-term and impending earthquake and the relationship between the pre-earthquake thermal infrared temperature anomaly and its change are:
(1) time: 10 to 20 days before an earthquake of magnitude 5 or greater (M≧5), the area of the temperature anomaly can reach 100,000 to 600,000 square kilometers, in a region with a thicker rock layer the temperature anomaly appears 30 to 120 days before the earthquake, and the earthquake usually takes place within 10 days after the sub-sound wave anomaly appears;
(2) epicenter: in a first type of epicenter the temperature anomaly appears in the future epicenter and in a surrounding area and as the temperature increase expands in the outer area and encroaches upon the epicenter, the two temperature increase anomaly areas converge and the verge where the temperature anomaly moves forward is the future epicenter, or a leading edge of a forward arm-shaped anomaly becomes the future epicenter; and in a second type of epicenter the temperature anomaly appears as an outer ring and moves inward as time goes by, wherein the future epicenter is where the temperature increase zone is moving forward or converges with the structure belt or an earthquake belt for that geographic area and in which the anomaly enters; and
(3) magnitude: an earthquake of magnitude 5 or greater (M≧5) usually covers an area of 100,000 square kilometers, an earthquake of magnitude 6 or greater (M≧6) usually covers an area of 400,000 square kilometers, and an earthquake of magnitude 7 or greater (M≧7) usually covers an area of 700,000 square kilometers; wherein:
before the occurrence of an earthquake the temperature anomaly might appear as a ring of temperature decrease above an earthquake-pregnant area, strange-shaped clouds might appear above the earthquake-pregnant area, and the temperature anomaly might appear in a low-lying river valley in an inland area, and by linking the temperature increase areas certain stress heat lines can be seen to converge at the future epicenter, thereby providing an indication of the future epicenter.

2. The method of short-term and impending earthquake prediction as claimed in claim 1 wherein:
the temperature brightness categories of latitudes N40° and N10° to N35° are separated, with a temperature value of 1° K for latitude N40°, and between 2° K and 3° K for latitude N10° to N35°, and for a tropical region the temperature value is 5.0° K and for a polar region the temperature value is 0.5° K.

3. The method of short-term and impending earthquake prediction as claimed in claim 1 wherein:
infrasonic sound measuring instruments are used to detect infrasonic sound anomalies in an earthquake prone area to improve the accuracy of predicting the time, epicenter and magnitude of an earthquake.

4. The method of short-term and impending earthquake prediction as claimed in claim 3 wherein:
a network of infrasonic sound measuring instruments are provided, enabling the network to utilize the differences in time in detection of the signals by the infrasonic instruments to tell from which direction the sound comes, thereby enabling the location of the epicenter to be accurately predicted.

5. A method of short-term and impending earthquake prediction comprising the steps of:
using an extreme-orbit satellite, a stationary satellite, a meteorology satellite and small satellite groups loaded with infrared wave scanners, receivers and image processors to detect and process thermal infrared wave and short-wave temperature brightness anomalies;
categorizing the color densities of the detected thermal infrared images and applying them to different seasons and different latitudes to obtain an atmospheric model;
using the scanners to detect the grayness value of the images, from which the actual temperature can be obtained by modifying the atmospheric model to compensate for different climates and terrain; wherein:
temperature brightness anomalies that are precursors of a short-term or impending earthquake are: a ring of temperature decrease appearing above a cloud layer over an area where an earthquake is breeding; strange-shaped clouds occurring over an area where an earthquake is breeding; and in an inland highland area certain thermal stress lines can be observed, the area where the stress lines converge indicating the future epicenter for an earthquake.
